(19) United States
(12) Patent Application Publication
(10) Pub. No.: US 2004/0006612 A1
(43) Pub. Date: Jan. 8, 2004

(54) Apparatus and method for SAN configuration verification and correction

(76) Inventors: Mahmoud Khaled Jibbe, Wichita, KS (US); Heng Po Chan, Wichita, KS (US); Kenneth Fugate, Wichita, KS (US); Miriam Savage, Wichita, KS (US); Christina Stout, Wichita, KS (US)

Correspondence Address: LSI Logic Corporation, Corporate Legal Department, Intellectual Property Services Group, 1551 McCarthy Boulevard, M/S D-106, Milpitas, CA, 95035, US

(21) Appl. No.: 10/185,379

(22) Filed: Jun. 28, 2002

(51) Int. Cl. G06F 15/173

(52) U.S. Cl. 709/223

(57) ABSTRACT

The present invention provides an apparatus and method for verifying and correcting storage area network (SAN) configuration information. With the apparatus and method of the present invention, configuration information is collected from components of the SAN using a SAN configuration scanning device. The configuration information collected by the SAN configuration scanning device is then compared to certified configuration parameters by a SAN configuration verification device. The comparison results in variances between the collected configuration information and the certified configuration parameters. It is then determined whether these variances are correctable or not. The variances that are correctable are corrected to reflect the certified configuration parameters by a SAN configuration correction device. Variances that are not correctable are output to an error report generation device that generates an error report for use by a SAN system administrator. The above functions of the present invention can be performed from a location remote from the actual physical location of the SAN.

### BACKGROUND OF THE INVENTION

1. Technical Field

The present invention is directed generally toward an improved computing system. More specifically, the present invention is directed to an apparatus and method for identifying faults in a complex storage network configuration by capturing storage area network (SAN) configuration information and comparing it to certified configuration information.

2. Description of the Related Art

One of the most common problems detected at a customer site or in a lab environment is the usage and construction of unsupported configurations or uncertified components, i.e. SAN hardware devices. This problem is typically caused by common users attempting to configure, e.g., set user definable operational parameters in the configuration file for the SAN component, SAN components without knowing the proper configurations for these SAN components and thus, such users attempt to configure these components using trial and error. Since it is not feasible to verify the operation of a SAN component for every possible configuration, there may be combinations of operational parameters that will cause the SAN component not to function properly within the SAN. This is especially true when a user attempts to cure a failure in a SAN component by reconfiguring it without any analysis as to the source of the failure.

Other sources of configuration problems in SANs come from, recommendations by sales representatives and the availability of different SAN components, i.e. components not specifically designed for the particular SAN, at a customer site during a system upgrade. This problem can only be detected by going to the customer site or lab and manually checking the configuration of the storage area network (SAN). This configuration validation is time consuming and is prone to failure because of human error by the human debugger that is checking the configuration of the SAN.

Uncertified configurations can cause a complete SAN system to be inoperative due to the incompatibility in the interfaces of the SAN components. For example, in a fibre channel based SAN, a component can initialize as a F (fabric) port or a FL (loop port) port type component. F port devices cannot communicate directly with FL port devices and vice versa. Thus, there is an incompatibility in the interfaces of the SAN components. Therefore, it would be beneficial to have an apparatus and method for verifying and correcting SAN configurations that does not require a technician to travel to the customer site and is not prone to human error. Furthermore, it would be beneficial to have an apparatus and method for correcting SAN configurations which can be performed automatically based on detected variances in configuration information from certified configuration information.

### SUMMARY OF THE INVENTION

The present invention provides an apparatus and method for verifying and correcting storage area network (SAN) configuration information. With the apparatus and method of the present invention, configuration information is collected from components of the SAN using a SAN configuration scanning device. The configuration information collected by the SAN configuration scanning device is then compared to certified configuration parameters by a SAN configuration verification device. The comparison results in variances between the collected configuration information and the certified configuration parameters.

It is then determined whether these variances are correctable or not. The variances that are correctable are corrected to reflect the certified configuration parameters by a SAN configuration correction device. Variances that are not correctable are output to an error report generation device that generates an error report for use by a SAN system administrator.

The above functions of the present invention can be performed from a location remote from the actual physical location of the SAN. For example, the present invention may be implemented on a server coupled to a SAN master server via one or more networks. Configuration information may be obtained from the SAN master server by querying the SAN master server for this configuration information or querying the individual components of the SAN directly.

Similarly, correction of the SAN configuration information may be performed from a remote location relative to the physical location of the SAN. With the present invention, the collected configuration information may be modified based on the comparison so that configuration information that differs from the certified configuration parameters is changed to reflect the certified parameters. This modified configuration information may then be transmitted back to the SAN master server for use in reconfiguring the SAN components. In this way, the present invention provides a mechanism for verifying and correcting SAN configurations from a remote location. Furthermore, the correction of the configuration information may be performed virtually automatically without the need for manual input of the corrected configuration parameters.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is an exemplary block diagram of a network computing system in which the present invention may be implemented;

FIG. 2 is an exemplary block diagram of a configuration verification server in accordance with an exemplary embodiment of the present invention;

FIG. 3 is an exemplary diagram of a storage area network (SAN) in accordance with the present invention;

FIG. 4 is an exemplary diagram illustrating the interaction of the primary operational components of the present invention;

FIG. 5 is a flowchart outlining an exemplary operation of the present invention; and

FIG. 6 is an exemplary diagram of a variance report in accordance with the present invention.

### DETAILED DESCRIPTION

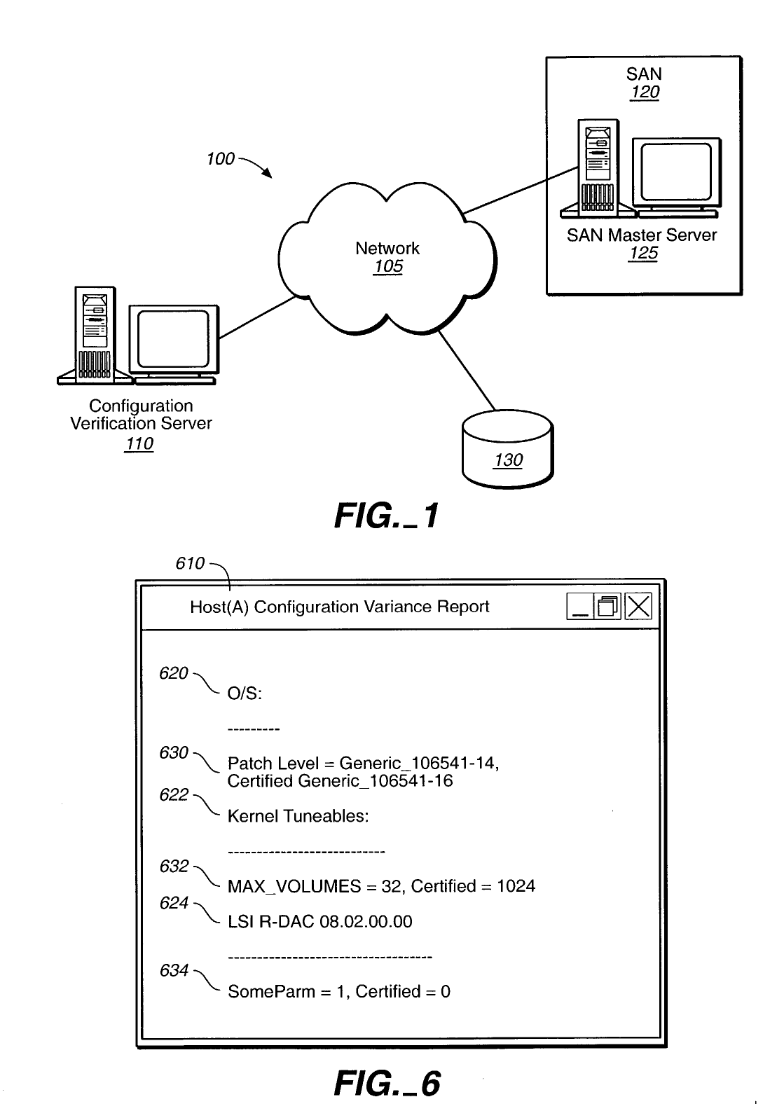

With reference now to the figures, FIG. 1 depicts a pictorial representation of a network of data processing systems in which the present invention may be implemented. Network data processing system 100 is a network of computers in which the present invention may be implemented. Network data processing system 100 contains a network 105, which is the medium used to provide communications links between various devices and computers connected together within network data processing system 100. Network 105 may include connections, such as wire, wireless communication links, or fiber optic cables.

In the depicted example, server 110 is connected to network 105 along with storage area network (SAN) master server 125 of SAN 120. Also connected to network 105 is storage system 130. The server 110 may communicate with the SAN 120 and storage system 130 via sending and receiving messages and data across network links in the network 105.

In the depicted example, network data processing system 100 is the Internet with network 105 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

As shown in FIG. 1, the server 110 is a configuration verification server which implements the apparatus and methods of the present invention, as described hereafter. It should be appreciated, however, that the present invention is not limited to being implemented on a server and may be implemented in a client device or a combination of a client device and a server. In the depicted example, the present invention is implemented in a configuration verification server 110.

The configuration verification server 110 collects configuration information from SAN 120 and compares it to certified configuration parameters for the SAN components stored in the storage system 130. The configuration verification server 110 then generates variance reports based on the comparison. Each variance report is then examined to determine if the variance is correctable. Such a determination may be based, for example, on whether an entry in the certified configuration parameters database exists for that portion of the configuration information. If the certified configuration parameters database does not have an entry for that portion of configuration information, then the variance is not correctable.

If the variance is correctable, the configuration verification server 110 corrects the configuration information by setting the varying parameters in the collected configuration information to the parameter values of the certified configuration parameters. If the variance is not correctable, an error report is generated and the SAN system administrator is notified of the error by sending the error report to the SAN master server.

It should be appreciated that, while the preferred embodiments are implemented such that remote SAN configuration verification and correction is performed, the present invention can be implemented locally with regard to the SAN 120. That is, for example, the apparatus and methods of the present invention may be implemented completely within the SAN 120. Alternatively, the apparatus and methods of the present invention may be distributed over a plurality of different network devices both within and exterior to the SAN 120.

In addition, although storage system 130 is shown as being coupled to the network 105, the present invention is not limited to such. Rather, the storage system 130 may be directly coupled to the configuration verification server 110, may be part of the SAN 120, or the like. The location and connectivity of the storage system 130 is not limited by the present invention.

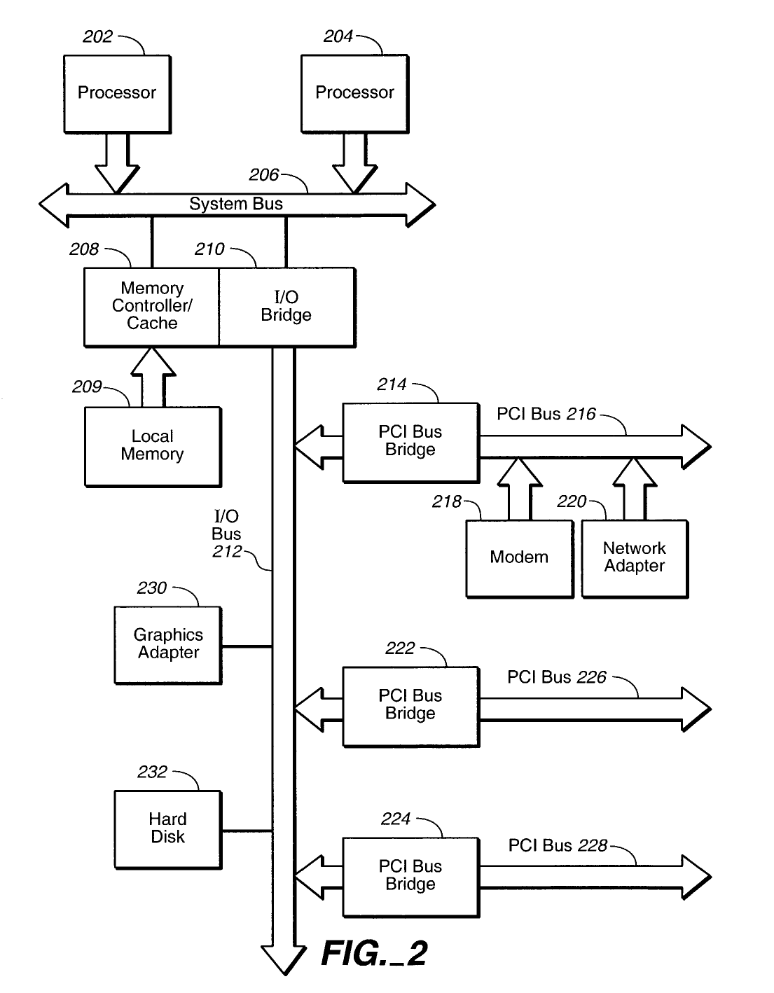

Referring to FIG. 2, a block diagram of a data processing system that may be implemented as a server, such as server 110 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

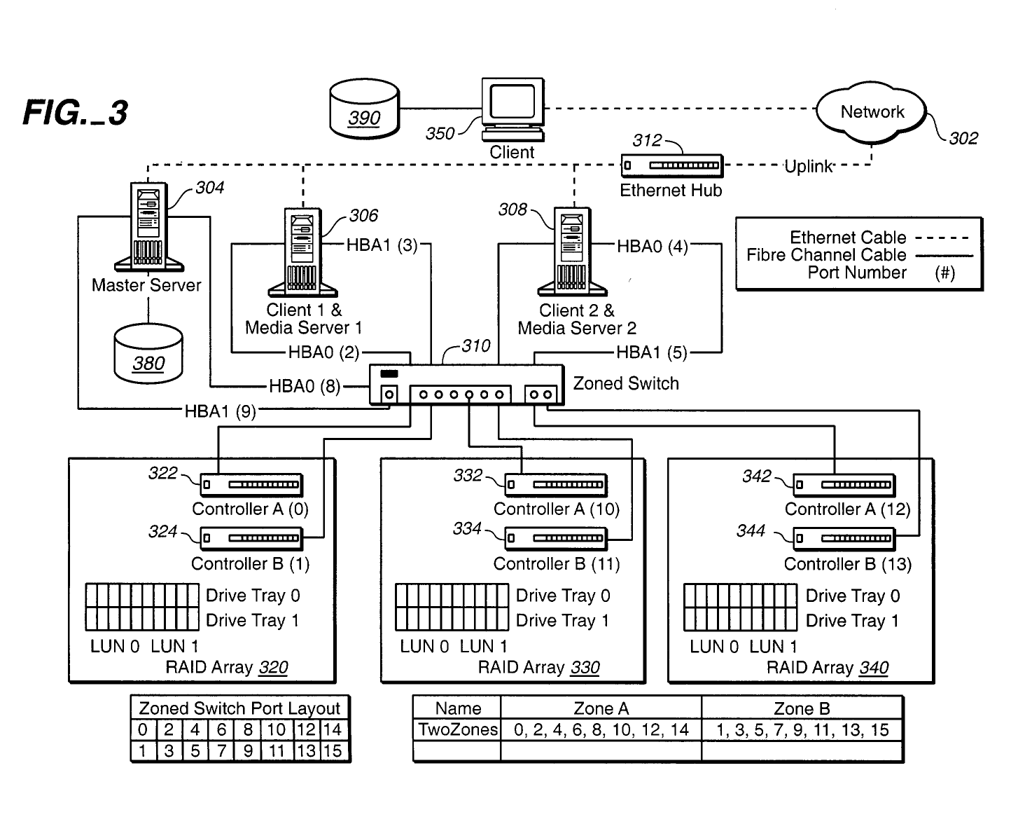

FIG. 3 is a block diagram illustrating an example storage area network in accordance with a preferred embodiment of the present invention. Master server 304 connects to client 1 and media server 1 306 and client 2 and media server 2 308 via Ethernet cable. Master server 304 connects to port 8 of zoned switch 310 using host bus adapter 0 (HBA0) via fibre channel cable. The master server also connects to port 9 of the zoned switch using host bus adapter 1 (HBA1). Similarly, client 1 306 connects to port 2 of the zoned switch using HBA0 and port 3 using HBA1. Client 2 308 connects to port 4 of the zoned switch using HBA0 and port 5 using HBA1.

The SAN also includes redundant array of inexpensive disks (RAID) arrays 320, 330, 340. In the example shown in FIG. 3, RAID array 320 includes controller A 322 and controller B 324. Controller A 322 connects to port 0 of zoned switch 310 via fibre channel cable and controller B 324 connects to port 1. RAID array 330 includes controller A 332 and controller B 334. Controller A 332 connects to port 10 of the zoned switch and controller B 334 connects to port 11. Similarly, RAID array 340 includes controller A 342 and controller B 344. Controller A 342 connects to port 12 of switch 310 and controller B 344 connects to port 13.

As depicted in FIG. 3, switch 310 is a zoned switch with zone A and zone B. Zone A includes ports 0, 2, 4, 6, 8, 10, 12, and 14 and zone B includes ports 1, 3, 5, 7, 9, 11, 13, and 15. Logical unit number (LUN) 0 and LUN 1 from RAID array 320 are mapped to master server 304. LUN 0 and LUN 1 from RAID array 330 are mapped to media server 1 306. And LUN 0 and LUN1 from RAID array 340 are mapped to media server 2 308.

The architecture shown in FIG. 3 is meant to illustrate an example of a SAN environment and is not meant to imply architectural limitations. Those of ordinary skill in the art will appreciate that the configuration may vary depending on the implementation. For example, more or fewer RAID arrays may be included. Also, more or fewer media servers may be used. The configuration of zones and ports may also change depending upon the desired configuration. In fact, switch 310 may be replaced with a switch that is not zoned.

Master server 304, media server 1 306, and media server 2 308 connect to Ethernet hub 312 via Ethernet cable. The Ethernet hub provides an uplink to network 302. In accordance with a preferred embodiment of the present invention, client 350 connects to network 302 to access components in the SAN. Given the Internet protocol (IP) addresses of the components in the SAN, client 350, a configuration verification server 110, or a client 350 via a configuration verification server 110, may scan the components for specifications and configuration information, such as settings, driver versions, and firmware versions. Alternatively, the configuration information for the SAN components may be stored in a database 380 associated with the SAN that is accessible through the master server 304, for example. The client may then compare this information against a database 390 of certified configurations. Any components or configurations that do not conform to the certified configurations may be isolated as possible sources of fault. Correctable configuration parameters may be automatically corrected by updating the settings, drivers, and firmware to those values and versions indicated in the certified configurations.

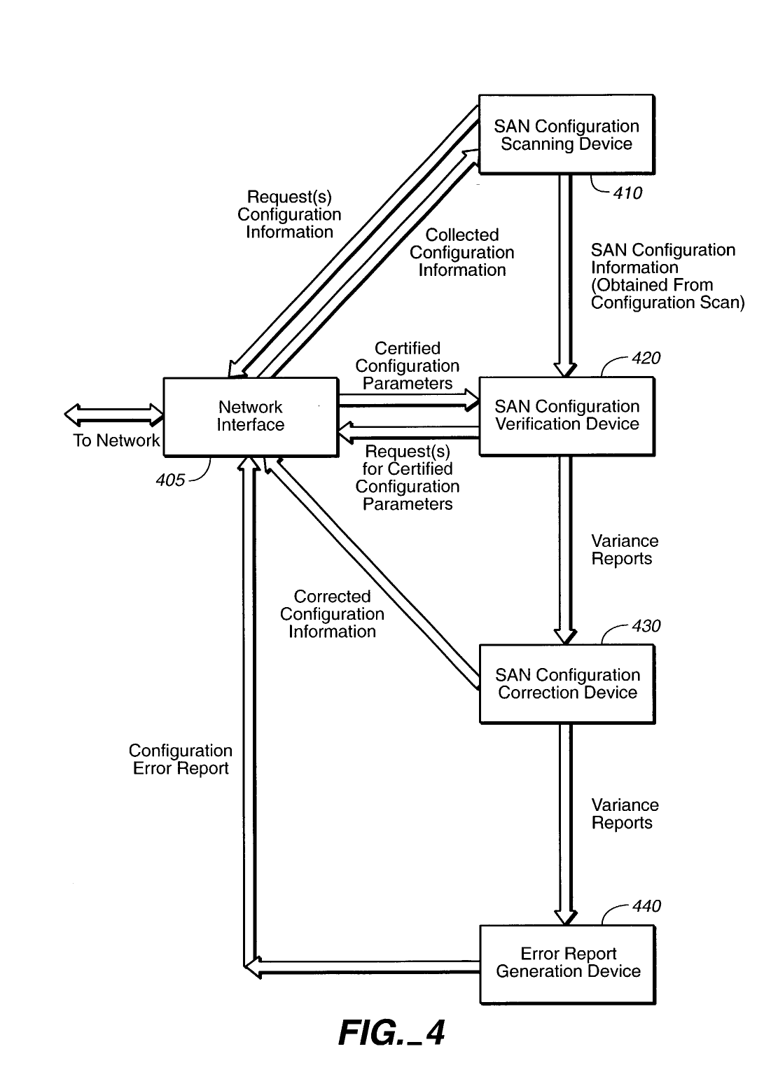

FIG. 4 is an exemplary diagram illustrating the interaction of the primary operational components of the present invention. As previously noted above, in a preferred embodiment, the operational components shown in FIG. 4 are implemented in either a client device, such as client 350, in a configuration verification server 110 at a remote location from the physical location of the SAN 120, or a combination of the client 350 and the configuration verification server 110. In a preferred embodiment, the mechanisms of the present invention are implemented in a configuration verification server 110 that communicates with the SAN remotely via a network, such as network 302.

In addition, the operational components shown in FIG. 4 may be implemented in software, hardware, or any combination of software and hardware. In a preferred embodiment, the operational components of the present invention are implemented as software instructions executed by one or more computer processing devices.

As shown in FIG. 4, the configuration verification and correction apparatus of the present invention includes a network interface 405, a SAN configuration scanning device 410, a SAN configuration verification device 420, a SAN configuration correction device 430 and an error report generation device 440. Communication between these elements may be performed in any known manner. In a preferred embodiment, communication between these elements is provided via a control/data signal bus (not shown) coupled to the elements 405-440.

In operation, a configuration verification process is initiated thereby causing the SAN configuration scanning device 410 to send one or more requests for configuration information to the SAN via the network interface 405. The configuration verification may be initiated, for example, in response to human input or detection of an event. For example, a human administrator may input a command to perform configuration verification of a particular SAN in response to a notification that the SAN is not working properly. The human administrator may input, for example, the address of the SAN master server so that the SAN configuration scanning device 410 may send requests to this address for configuration information. Alternatively, the SAN master server may automatically send a request for verification to the configuration verification server in response to a detected error. Other mechanisms for initiating a SAN configuration verification may be used without departing from the spirit and scope of the present invention.

In one exemplary embodiment, the configuration information for the SAN is stored in a centralized location in a SAN configuration database, such as database 380. Thus, the request sent from the SAN configuration scanning device 410 may be a simple request for the configuration information from this database. The request may be authenticated by the SAN master server, and upon the request being determined to originate from an authenticated configuration verification server, the SAN master server may respond with the requested configuration information.

In an alternative embodiment in which configuration information is not centralized in the SAN master server, the particular requests sent to obtain the configuration information include a first request for obtaining identification information regarding the various components in the SAN and one or more subsequent requests based on the particular components identified in response to the first request. The subsequent requests for configuration information may be generated by various scan methods, the methods used being dependent on the type of components identified in the SAN. Thus, after having received a response to the first request for configuration information, each subsequent request for more specific component configuration information involves a first operation for determining the particular method to be used in generating the subsequent request and then a second operation of invoking the method to actually retrieve the configuration information from the particular component.

For example, Table 1 illustrates a plurality of different SAN component types and their corresponding method for obtaining configuration information. Depending on what components a particular SAN may have, various ones of these methods may be identified and invoked in order to obtain the SAN configuration information for verification.

TABLE 1
Component and Corresponding Configuration Scan Method

| Component | |
|---|---|
| Type | Method |
| Host Model | Collect, from the configuration information database, the |
| | list of required system files to parse respective of the |
| | host platform (Operating System, vendor) and respective |
| | of the component. Read these system files for the |
| | comment tags surrounding configuration information, or |
| | use a parse tool to extract the configuration information |
| | based on static location in the file. |
| Host | Collect, from the configuration information database, the |
| Adapter | list of required system files to parse respective of the |
| | host platform (Operating System, vendor) and respective |
| | of the component. Read these system files for the |
| | comment tags surrounding configuration information, or |
| | use a parse tool to extract the configuration information |
| | based on static location in the file. |
| Switch | Collect, from the configuration information database, the |
| | list of required switch resources to parse respective of |
| | the switch and topology access (Telnet, rsh, TTY, etc.). |
| | Read from the database the necessary comnmands that are |
| | to be issued to the switch for obtaining the configuration |
| | information (e.g., switch “Show” commands to get |
| | switch model, statistics, and Name server contents, port |
| | # port type, zone. etc.). |
| HUB | Collect, from the configuration information database, the |
| | list of required HUB resources to parse respective of the |
| | switch and topology access (Telnet, rsh, TTY, etc.). |
| | Read from the database the necessary commands that are |
| | to be issued to the HUB for obtaining the configuration |
| | information (e.g., portshow #, for each available port on |
| | the respective HUB model, etc.). |
| RAID | Collect, from the configuration information database, the |
| Module | list of required resources to parse respective of the Array |
| | and topology access. For example, Telnet to the RAID |
| | controller module and issue FC shell commands (ALL, |
| | 5, 10 and 120 to get RAID FW, configuration, model, |
| | statistics, connectivity, port type, etc.) or Fibre channel |
| | inquiry 12 with different page selects, drive tray ESM |
| | and disk drive NV/NVS RAM page configurations |
| | respective to ESM/Drive FW version. etc. |
| Tape | Collect, from the configuration information database, the |
| | list of required resources to parse respective of the tape |
| | and topology access (Telnet, rsh, TTY). Read from the |
| | database the necessary commands that are to be issued to |
| | the Tape for obtaining the configuration information. |
| Router | Collect, from the configuration information database, the |
| | list of required resources to parse respective of the |
| | Router and topology access (Telnet, rsh, TTY). Read |
| | from the database the necessary commands that are to be |
| | issued to the Router for obtaining the configuration |
| | information. |

The configuration scan performed by the SAN configuration scanning device 410 uses a repository to store two classes of information. The first class of information contains the method used to collect the target component configuration information. Tables 2-5 illustrates some exemplary methods for various operating systems and various SAN components that may be used to obtain the configuration information for these components.

TABLE 2
Host Configuration Scan Methods

| Host Methods | PseudoCode |
|---|---|
| Windows | Registry |
| (Perl script, shell, API) that connects | Key Name: SOFTWARE\Storage\RDAC |

| | | |
|---|---|---|
| (telnet, Agent) to a given IP address | Name: | Version |
| defined by the connectivity scan and parses | Data: | 98.20.90.02 |

| | |
|---|---|
| the defined parameters required by the | Devices |
| repository | (Perl script or API to read the driver version data) |
| | WWN |
| | (Perl script to read SNIA or vendor specific API data) |
| | \\<window>\system32\drivers\etc (read various system config files) |
| Linux | \etc\modules.com |
| (Perl script, shell, API) that connects | options scsi_mod max_scsi_luns=40 |
| (telnet, Agent) to a given IP address | options qla2300 ConfigRequired=1 q12xopts=scsi-qla0-adapater-... |
| defined by the connectivity scan and parses | |
| the defined parameters required by the | \proc\scsi\<hab> |
| repository | QLogic PCI to Fibre Channel Host Adapter for ISP21xx/ISP22xx/ISP23xx |

Firmware version: 3.00.36, Driver version 5.38b13T2-fo

SCSI Device Information:
scsi-qla1-adapter-node=200000e08b054c63;
scsi-qla1-adapter-port=210000e08b054c63;
scsi-qla1-port-0=200a00a0b8001dbc:200b00a0b8001dbd;
scsi-qla1-port-1=200a00a0b80664d1:200b00a0b80664d2;

TABLE 3
HBA Configuration Scan Methods

| HBA Methods | PseudoCode | |
|---|---|---|
| Windows QLogic | Registry | |
| (Perl script, shell, API) that connects | Key Name: | SYSTEM\CurrentCountrolSet\Services\q12200\Parameters\Device |

| | | |
|---|---|---|
| (telnet, Agent) to a given IP defined by | Data: | UseSameNN=1; BusChange=0; |

| | |
|---|---|
| the connectivity scan and parses the | Devices |
| defined parameters required by the | (Pert script or API to read the driver version data) |
| repository | WWN |
| | (Perl script to read SNIA or vendor specific API data) |
| | \\<windows>\system32\drivers\etc (read various system config files) |
| Solaris JNI | 1. Read the Configuration file. |

| | |
|---|---|
| (Pert script, shell, API) that connects | a. Go to /kernelldrv/<filename>.conf, (eg. jnix/46.conf) |

| | |
|---|---|
| (telnet, Agent) to a given IP defined by | Read the topology. |

| | |
|---|---|
| the connectivity scan and parses the | FcLoopEnabled = 0; |
| defined parameters required by the | FcFabricEnabled = 1; |
| repository | FcPortCfgEnable = 0; |

| | |
|---|---|
| b. | Read the bus failover delay = 30 |
| c. | Read the INlcreationDelay=10 or Scsi_probe_delay=5000 |
| d. | Read the bindings. Execute genscsiconf jo generate the binding |

if needed.
#Example usage:
#automap =0;
#jnic0-automap=0;

# target Bindings generated by the /etc/raid/bin/genjniconf
script

| | |
|---|---|
| target0_hba | =“jnic1”; |
| target0_wwnn | =“200600A0B8001DC4”; |
| target0_wwpn | =“200600a0b8001dc5”; |
| target1_hba | =:jnic2”; |
| target1_wwnn | =“200600A0B8001DC4”; |
| target0_wwpn | =“200700a0b8001dc5”: |

| | |
|---|---|
| Linux QLogic | \etc\modules.com |
| Script (Perl, shell) that telnets to a given | options qla2300 ConfigRequired=1 ql2xopts=scsi-qla0-adapater-... |
| IP defined by the connectivity scan and | |
| parses the defined parameters required | \proc\scsi\<hab> |
| by the repository | QLogic PCI to Fibre Channel Host Adapter for ISP21xx/ISP22xx/ISP23xx: |

Firmware version: 3.00.36, Driver version 5.38bl3T2-fo

SCSI Device Information:
scsi-qla1-adapter-node=200000e08b054c63;
scsi-qla1-adapter-port=210000e08b054c63;
scsi-qla1-port-0=200a00a0b8001dbc:200b00a0b8001dbd;
scsi-qla1-port-1=200a00a0b80664d1:200b00a0b80664d2;

TABLE 4
Switch Configuration Scan Methods

| Switch Methods | PseudoCode | |
|---|---|---|
| Brocade | fabric.ops.BBCredit: | 16 |
| Script (Perl, shell) that | fabric.ops.E_D_TOV: | 2000 |
| telnets to a given IP defined | fabric.ops.R_A_TOV: | 10000 |

| by the connectivity scan | Fabric OS: v3.0.2 | |
|---|---|---|
| and parses the defined | port 0: sw Online | F-Port 21:00:00:e0:8b:04:38:4d |

| parameters required by the | zone: zone_1 1,0; 1,1; 1,2; 1,3 |
|---|---|
| repository | |
| | switch:admin> nsShow |
| | The Local Name Server has 4 entries { |

| | | | | | |
|---|---|---|---|---|---|
| Type | Pid COS | PortName | NodeName | TTL(sec) | Fabric Port Name: |
| N | 011...;3; | 20:16:00:....; | 20:16:00:... | na FC4s:FCP [LSI...; | 20:02:00:60:... |
| N | 011...;3; | 20:17:00:....; | 20:16:00:... | na FC4s:FCP [LSI...; | 20:03:00:60:... |
| N | 011...;2,3; | 20:18:00:....; | 20:18:00:... | na FC4s:FCP [LSI...; | 20:04:00:60:... |
| N | 011...;2,3; | 20:19:00:....; | 20:18:00:... | na FC4s:FCP [LSI...; | 20:05:00:60:... |

| | } | |
|---|---|---|
| SanBox2 | R_T_TOV | 100 |
| Script (Perl. shell) that | R_A_TOV | 10000 |
| telnets to a given IP defined | E_D_TOV | 2000 |

| | | | |
|---|---|---|---|
| by the connectivity scan | 0 | Port0 Online | GL Auto |

| | | | |
|---|---|---|---|
| and parses the defined | 0 | F | 20:00:00:c0:dd:00:cd:4e N 20:00:00:e0:8b:05:4b:63... |
| parameters required by the | | | |
| repository | | | |

TABLE 5
RAID Configuration Scan Methods

| RAID Methods | PseudoCode | |
|---|---|---|
| Shell Commands | Module data: | |
| Script (Perl, shell) that | −> moduleList | |
| telnets to a given IP | ==================================== | |
| defined by the | Title: | Disk Array Controller for SHV 960 platform |
| connectivity scan and | | Copyright 1999-2002, LSI Logic Storage Systems, Inc. |
| parses the defined | | |
| parameters required by the | Name: | shv |
| repository. Using the | Version: | 95.20.27.00 |
| Shell a connect-the-dot | Date: | Jan. 30, 2002 |
| method can be used to | Time: | 12:03:19 |
| detect which host is | Models: | 2662 2772 |
| connected to which port. | Manager: | devmgr.v0820api07.Manager |

| Knowing the port, then the | ==================================== | | | | | | | | | |
|---|---|---|---|---|---|---|---|---|---|---|
| port type (O/S) can be | −> fcAll | | | | | | | | | |
| determined | | | | | | | | | | |
| (smpShowHTPLabels). | fcAll (Tick 0000090469) ==> Feb. 08, 2002-18:16:42 (GMT) | | | | | | | | | |
| Then a symbol call similar | | | | | | | | | | |
| to (getObjectGraph_MT) | | | | | | | | | | |
| will show required | 2772-A | | Our | Num | ::. . .Exchange Counts. . .:: | | | Num | ..Link | Up.. |
| parameters. And the user | Chip | LinkStat | Port | Port | :: | | :: | Link | Bad | Bad |
| region of the NVRAM can | | | ID | Logi | ::Open | Total | Errors:: | Down | Char | Frame |
| be inspected and | 0-Dst | Up-Loop | 1 | 10 | :: 10 | 400197 | 18:: | 3 | 0 | 0 |
| compared to the expected | 1-Dst | Up-Loop | 1 | 10 | :: 5 | 412075 | 11:: | 3 | 0 | 0 |
| values for the given O/S. | 2-Src | Up-Fab | 11400 | 3 | :: 65 | 89624 | 490:: | 1 | 0 | 0 |

| | |
|---|---|
| Some, Symbol and CLI | −> fcChip=2 |
| commands will he use to | |
| determine RAID array | −> fc 10 |
| characteristics such as: | |

| | | |
|---|---|---|
| · | No. of drives | fc 10 CHIP: 2 Src chan: 0 (Tick 0000090944) ==> Feb. 08, 2002-18:16:50 (GMT) |
| | connected | |

| | (example FCDevs) | Role | Chip | PortId | PortWwn | NodeWwn | DstNPort |
|---|---|---|---|---|---|---|---|
| · | Controller is active | | | | | | |
| | or failed (example | Dflt | 2 | fffffe | 00000000-00000000 | 00000000-00000000 | a1252390 |
| | | This | 2 | 011400 | 000000a0-b80b557e | 000000a0-b80b557e | a125240c |
| | arraySummaryPrint) | Host | 2 | 011600 | 210000e0-8b016fec | 200000e0-8b0173ec | a1252580 |
| · | Redundant loop | Host | 2 | 011000 | 210000e0-8b02a327 | 200000e0-8b02a327 | a1252504 |

| connections on the | −> spmShow | | | |
|---|---|---|---|---|
| drive side (example | SPM controllerRef=070000000000000000000001 | | | |
| TBD) | SAP | SAPORT_REF | CONTROLLER_REF | PORT SAPRTGRP_REF (0x2000000) |

| | | | | | |
|---|---|---|---|---|---|
| · | Mini-Hub Failures | SAP | 800301000000 | 070000000000000000000001 | 0 000000000000 |
| | (example TBD) | SAP | 800301000001 | 070000000000000000000002 | 0 000000000000 |

| | |
|---|---|
| SG | SAPRTGRP_REF LABEL (0xa0b99b5c) |

| Host Ports | | | |
|---|---|---|---|
| HOSTPORT REF TYPE NAME | | LABEL | HOST REF (0xa0b9a0b4) |
| 820308000000 | 1 0x210000E08B02A37 | Noah-1 | 8403010... |

| Fibre Inquiries | Inquiry 0x12 can be used to read VPD pages and connect-the-dots for a |
|---|---|
| Script (Perl, shell) that can | respective Array Module. |
| issue FC command to a | |
| given Array target WWN | 0x00 Supported Vital Product Data Pages |
| defined by the | 0xC2 Supported Features, DCE, AVT, DBE... |
| connectivity scan and | 0xC9 AVT enabled |
| parses the defined | 0xC4 Controller Type 4884, 4774 |
| parameters required by the | ... |
| repository | 0xD0 Storage Array WWN... |
| | Most Important will be a SYMBOL call to the controller requesting |
| | (getObjectGraph) |
| | ... |

In response to the requests for configuration information, the SAN configuration scanning device 410 receives SAN configuration information from the SAN master server and/or the components of the SAN. The SAN configuration scanning device 410 then forwards this configuration information to the SAN configuration verification device 420. The SAN configuration verification device 420 then identifies the component types in the SAN configuration information received and sends requests for certified configuration parameters for these component types to the certified configuration parameters database, e.g., database 390.

In response to these requests, the SAN configuration verification device 420 receives the certified configuration parameters and performs a comparison of the certified configuration parameters and the collected configuration information. The certified configuration parameters are parameters that are known to be valid for the particular component for use in storage area networks. In other words, if the certified configuration parameters are utilized in configuring the SAN component, failure of the component or the SAN will be avoided.

The comparison of the collected configuration information with the certified configuration parameters may take the form of, for example, identifying variable names and their corresponding values in the collected configuration information, and comparing them to corresponding variable names and their values in the certified configuration parameters. This comparison may take other forms including, a comparison of a formatted table of configuration information with a similarly formatted table of certified configuration parameters such that a comparison of similarly located table records may be performed. Differences between the collected configuration information and the certified configuration parameters are noted and used to create variance reports.

The variance reports are provided to the SAN configuration correction device 430 which analyzes the reports and determines if appropriate correction can be made. If so, the configuration information collected using the SAN configuration scanning device 410 is modified to overwrite configuration information that varies from the certified configuration parameters with the certified configuration parameters. This corrected configuration information is then sent to the SAN master server and/or the components of the SAN via the network interface 405.

If a variance in the configuration information cannot be corrected using the SAN configuration correction device 430, e.g., a corresponding certified configuration parameter does not exist for a variable present in the collected configuration information, the variance report is sent to the error report generation device 440 which generates an error report and outputs it to the SAN master server via the network interface. In an alternative embodiment, the variance reports may always be output to the SAN master server and/or output on a display device associated with the configuration verification server, so that system administrators may be informed of the variances even if those variances are corrected by the present invention.

Thus, the present invention provides a mechanism for verifying the configuration information of components of a storage area network (SAN). This verification may be performed automatically using a configuration verification server which compares collected configuration information with certified configuration parameters. In addition, the present invention provides a mechanism that may automatically correct errors in configuration information collected from a SAN. With the mechanism of the present invention, configuration information variances may be automatically modified to reflect the certified configuration parameters and thereby, assure that the components of the SAN will operate properly.

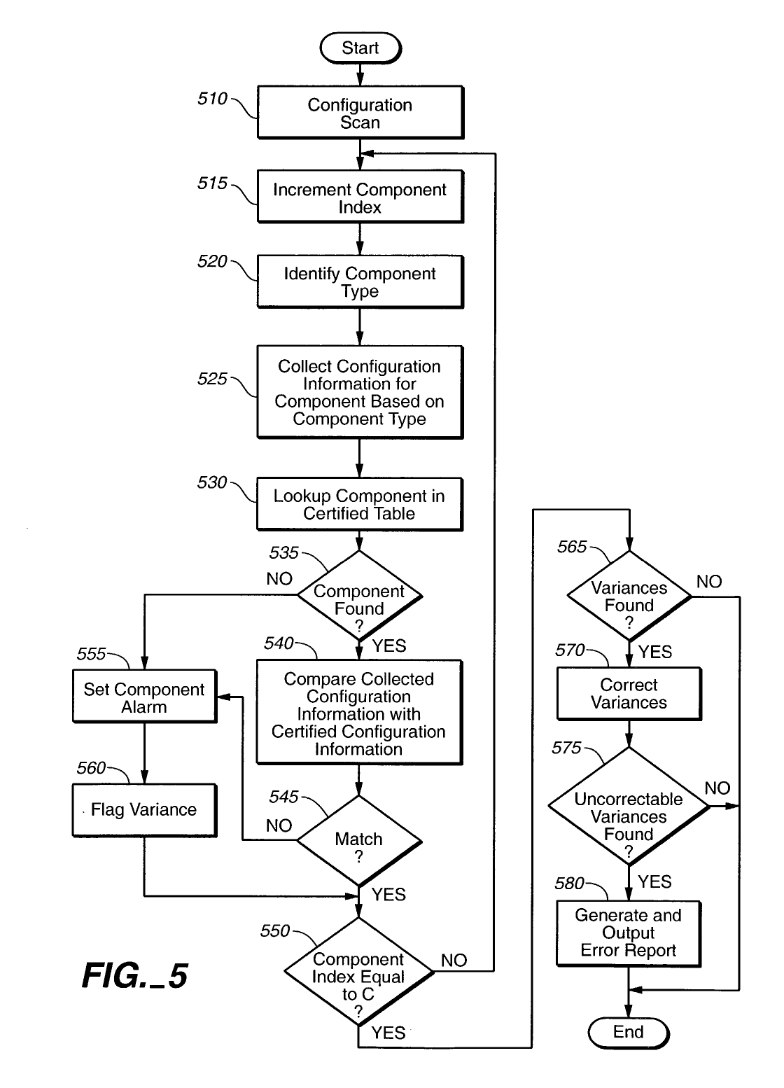

FIG. 5 is a flowchart outlining an exemplary operation of the present invention. As shown in FIG. 5, the operation starts with a configuration scan (step 510). This configuration scan provides information about the types of components in the SAN so that the present invention may determine how to obtain the configuration information for that component type.

The component index for the scan of the configuration information is incremented (step 515) and the component type for the next component in the configuration scan is identified (step 520). The configuration information for that component is then collected based on the identified component type (step 525). In other words, the particular method for obtaining the configuration information is determined based on the identified component type and the method is then invoked to obtain the configuration information.

The component type is looked-up in the certified table, i.e. the table identifying certified component information (step 530). A determination is made as to whether the component is found (step 535). If not, a component alarm is set (step 555) and a variance in the component configuration information is flagged (step 560). Otherwise, if the component is found in the certified table, the operation compares the collected configuration information with the certified configuration parameters identified in the certified table (step 540).

A determination is made as to whether there is a match between the collected configuration information and the certified configuration parameters (step 545). If not, the operation goes to step 555 where the component alarm is set and the variance is flagged (step 560). Otherwise, if there is a match, or after having set the component alarm and flagged the variance, a determination is made as to whether the component index is equal to the total number of components, C, in the configuration scan (step 550). If not, the operation returns to step 515 and repeats the operation for each subsequent component in the configuration scan until the component index equals C.

If the component index equals C, a determination is made as to whether any variances were found between the collected configuration information and the certified configuration parameters (step 565). If not, the operation ends. If there were variances identified, an attempt is made to correct those variances (step 570). A determination is then made as to whether any of the variances were not correctable (step 575). If not, the operation ends. If a variance was not correctable, an error report is generated and output (step 580).

Although not explicitly shown in FIG. 5, in addition to the functions performed, variance reports may be generated and output subsequent to step 560. These variance reports may always be output regardless of whether the variance is correctable or not in order to always provide the system administrators with information regarding changes being made to the SAN configuration or changes that need to be made to the SAN configuration.

FIG. 6 is an exemplary diagram of a variance report in accordance with the present Invention. As shown in FIG. 6, the variance report essentially is comprised of a component designation 610, parameter categories 620-624 and a listing of the collected configuration information paired with its corresponding certified configuration parameter 630-634. In the depicted example, the collected configuration information paired with the corresponding certified configuration parameter takes the form of:

Collected Configuration Information, Certified=Certified Configuration Parameter

For example, the collected configuration information may be MAX_VOLUMES=32 and the Certified Configuration Parameter may be that the maximum number of volumes is to be set to 1024. This variance report may take the form of a desktop window (as shown) or any other type of display. For example, the variance report may be a web page, series of web pages, series of windows, printable documents, or the like.

Thus, the present invention provides a mechanism for verifying the configuration of SAN components against certified configuration parameters. Moreover, the present invention provides an automated mechanism for performing such verification and for correcting configuration information that does not match the certified configuration parameters. In this way, the human element with regard to error is virtually eliminated in the verification and correction process.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of verifying network component configurations, comprising:
obtaining configuration information for at least one component of a network;
obtaining at least one certified configuration parameter for the at least one component;
comparing the configuration information to the at least one certified configuration parameter; and
verifying the configuration information for the at least one component based on the comparison of the configuration information to the at least one certified configuration parameter.

2. The method of claim 1, wherein verifying the configuration information includes identifying a variance between the configuration information and the at least one certified configuration parameter.

3. The method of claim 2, further comprising:
determining if the configuration information may be corrected; and
correcting the configuration information to include the at least one certified configuration parameter if the configuration information may be corrected.

4. The method of claim 2, further comprising:
determining if the configuration information may be corrected; and
generating an error report if the configuration information cannot be corrected.

5. The method of claim 2, further comprising:
generating a variance report identifying the configuration information and the at least one certified configuration parameter; and
outputting the variance report on a display device.

6. The method of claim 1, further comprising:
identifying a type of the at least one component;
identifying a method for obtaining the configuration information for the at least one component based on the type; and
invoking the method to thereby obtain the configuration information for the at least one component.

7. The method of claim 1, wherein the network is a storage area network and the at least one component is at least one hardware device in the storage area network..

8. The method of claim 7, wherein the method is performed by a computing device external to the storage area network.

9. The method of claim 7, wherein the method is performed by a computing device internal to the storage area network.

10. The method of claim 1, wherein the at least one component is at least one of a host bus adapter, a switch, a router, a hub, a RAID module, and a tape device.

11. The method of claim 4, wherein determining if the configuration information may be corrected includes determining if a portion of the configuration information does not have a corresponding parameter in the at least one certified configuration parameter.

12. The method of claim 1, wherein obtaining configuration information for the at least one component of the network includes sending a request to a configuration information database in which configuration information for components of the network is stored.

13. The method of claim 6, wherein identifying a method for obtaining the configuration information for the at least one component based on the type further includes identifying the method based on an operating system utilized by the network.

14. A computer program product in a computer readable medium for verifying network component configurations, comprising:
first instructions for obtaining configuration information for at least one component of a network;
second instructions for obtaining at least one certified configuration parameter for the at least one component;
third instructions for comparing the configuration information to the at least one certified configuration parameter; and
fourth instructions for verifying the configuration information for the at least one component based on the comparison of the configuration information to the at least one certified configuration parameter.

15. The computer program product of claim 14, wherein the fourth instructions for verifying the configuration information include instructions for identifying a variance between the configuration information and the at least one certified configuration parameter.

16. The computer program product of claim 15, further comprising:
fifth instructions for determining if the configuration information may be corrected; and
sixth instructions for correcting the configuration information to include the at least one certified configuration parameter if the configuration information may be corrected.

17. The computer program product of claim 15, further comprising:
fifth instructions for determining if the configuration information may be corrected; and
sixth instructions for generating an error report if the configuration information cannot be corrected.

18. The computer program product of claim 15, further comprising:
fifth instructions for generating a variance report identifying the configuration information and the at least one certified configuration parameter; and
sixth instructions for outputting the variance report on a display device.

19. The computer program product of claim 14, further comprising:
fifth instructions for identifying a type of the at least one component;
sixth instructions for identifying a method for obtaining the configuration information for the at least one component based on the type; and
seventh instructions for invoking the method to thereby obtain the configuration information for the at least one component.

20. The computer program product of claim 14, wherein the network is a storage area network and the at least one component is at least one hardware device in the storage area network.

21. The computer program product of claim 20, wherein the computer program product is executed by a computing device external to the storage area network.

22. The computer program product of claim 20, wherein the computer program product is executed by a computing device internal to the storage area network.

23. The computer program product of claim 14, wherein the at least one component is at least one of a host bus adapter, a switch, a router, a hub, a RAID module, and a tape device.

24. The computer program product of claim 17, wherein fifth instructions for determining if the configuration information may be corrected include instructions for determining if a portion of the configuration information does not have a corresponding parameter in the at least one certified configuration parameter.

25. The computer program product of claim 14, wherein the first instructions for obtaining configuration information for the at least one component of the network include instructions for sending a request to a configuration information database in which configuration information for components of the network is stored.

26. The computer program product of claim 19, wherein the sixth instructions for identifying a method for obtaining the configuration information for the at least one component based on the type further include instructions for identifying the method based on an operating system utilized by the network.

27. An apparatus for verifying network component configurations, comprising:
means for obtaining configuration information for at least one component of a network;
means for obtaining at least one certified configuration parameter for the at least one component;
means for comparing the configuration information to the at least one certified configuration parameter; and
means for verifying the configuration information for the at least one component based on the comparison of the configuration information to the at least one certified configuration parameter.

28. The apparatus of claim 27, wherein means for verifying the configuration information includes means for identifying a variance between the configuration information and the at least one certified configuration parameter.

29. The apparatus of claim 28, further comprising:
means for determining if the configuration information may be corrected; and
means for correcting the configuration information to include the at least one certified configuration parameter if the configuration information may be corrected.

30. The apparatus of claim 28, further comprising:
means for determining if the configuration information may be corrected; and
means for generating an error report if the configuration information cannot be corrected.

31. The apparatus of claim 28, further comprising:
means for generating a variance report identifying the configuration information and the at least one certified configuration parameter; and
means for outputting the variance report on a display device.

32. The apparatus of claim 27, further comprising:
means for identifying a type of the at least one component;
means for identifying a method for obtaining the configuration information for the at least one component based on the type; and
means for invoking the method to thereby obtain the configuration information for the at least one component.

33. The apparatus of claim 27, wherein the network is a storage area network and the at least one component is at least one hardware device in the storage area network.

34. The apparatus of claim 33, wherein the apparatus is part of a computing device external to the storage area network.

35. The apparatus of claim 33, wherein the apparatus is part of a computing device internal to the storage area network.

36. The apparatus of claim 27, wherein the at least one component is at least one of a host bus adapter, a switch, a router, a hub, a RAID module, and a tape device.

37. The apparatus of claim 30, wherein the means for determining if the configuration information may be corrected includes means for determining if a portion of the configuration information does not have a corresponding parameter in the at least one certified configuration parameter.

38. The apparatus of claim 27, wherein the means for obtaining configuration information for the at least one component of the network includes means for sending a request to a configuration information database in which configuration information for components of the network is stored.

39. The apparatus of claim 32, wherein the means for identifying a method for obtaining the configuration information for the at least one component based on the type further includes means for identifying the method based on an operating system utilized by the network.
